(19) United States
(12) Patent Application Publication
(10) Pub. No.: US 2020/0098024 A1
(43) Pub. Date: Mar. 26, 2020

(54) System and Method of Selecting and Commissioning a Tattoo Artist

(71) Applicant: Jacob J. Castro, Morrisville, PA (US)

(72) Inventor: Jacob J. Castro, Morrisville, PA (US)

(21) Appl. No.: 16/138,917

(22) Filed: Sep. 21, 2018

(51) Int. Cl. G06Q 30/06; G06Q 50/00

(52) U.S. Cl. CPC G06Q 30/0611; G06Q 50/01

(57) ABSTRACT

A system and method that enables a customer to commissioning a tattoo artist to create a tattoo that satisfies the customer's aesthetic as well as meet the customer's requirements for price and location convenience. The system utilizes at least one server that is accessible through a data network. A customer access the system using a customer computer. Tattoo artists access the system using various artist computers. Using the artist computers, each tattoo artist uploads profile information and a pictorial portfolio into a searchable database. Using the customer computer, a customer can search the system database using Boolean search parameters. This filters the profile information of tattoo artists by location, specialties and price to obtain a filtered selection of tattoo artists.

### BACKGROUND OF THE INVENTION

### 1. Field of the Invention

In general, the present invention relates to systems and method used to search artists, review the work of the artists, and commission the artists to create a piece of art. More particularly, the present invention relates to systems and methods to search, select, and hire tattoo artists.

### 2. Prior Art Description

A tattoo lasts for a lifetime. As such, great care should be made in selecting a tattoo and the tattoo artist entrusted to create the tattoo. Unfortunately, most customers of tattoos are limited to viewing pictures of tattoo art displayed in a local tattoo parlor. Otherwise, a tattoo customer must visit the websites of numerous different tattoo artists to review their work and their prices before traveling to the tattoo parlor.

Not all tattoo artists are the same. Some have far more talent than others. Furthermore, some tattoo artists have specialties that require custom tools and specific skills to use those tools. For example, most tattoo artists are capable of creating a tattoo on an arm or a leg. However, not all tattoo artists can tattoo the lips, ears, neck, eyelids and other less traditional parts of the anatomy. Such unique tattoos require specialized tools and specialized techniques. Likewise, many tattoo artists can create simplistic designs, such as a ship's anchor. However, only a select number of tattoo artists can create quality photorealistic tattoos of a particular person's face.

Accordingly, a person wanting a particular type of tattoo has to spend much time and effort researching different tattoo artists in order to find one who is qualified to create the desired tattoo. What often happens is that a person will select a tattoo artist who may not be as talented or as qualified as believed. The result is a tattoo that the customer does not like. The customer must then bear the undesirable tattoo for the rest of the customer's life.

Due to the permanent nature of a tattoo, individuals tend to take care in selecting a tattoo artist in order to avoid getting an undesirable tattoo. One of the most common ways of selecting a talented tattoo artist is to observe a quality tattoo on another individual and where the tattoo was obtained. This word of mouth system works well. However, often the tattoo was obtained far away or by a tattoo artist who may not still be in practice.

In the prior art, computer systems have been developed that enable a person to view tattoos and even visualize what a selected tattoo will look like on a particular part of their body. Such prior art computer systems are exemplified by U.S. Patent Application Publication No. 2011/0242132 to Bailey; U.S. Patent Application Publication No. 2006/0064310 to Briggs; and U.S. Patent Application Publication No. 2012/0040314 to Rubino. Although such prior art systems enable a person to view a sample tattoo, such systems provide little insight as to the ability of the tattoo artist to reproduce the selected tattoo on the selected part of the body.

A need therefore exists for a system and method that can enable a potential customer to review the work, style, specialties and prices of numerous tattoo artists. In this manner, a person can select a tattoo artist with the talent, experience and tools needed to produce a tattoo that will be desirable. This need is met by the present invention as described and claimed below.

### SUMMARY OF THE INVENTION

The present invention is a system that enables a customer to commission a tattoo artist to create a tattoo that satisfies the customer's aesthetic as well as meets the customer's requirements for price and location convenience.

The system utilizes at least one server that is accessible through a data network. A customer accesses the system using a customer computer. Tattoo artists access the system using various artist computers. Using the artist computers, each tattoo artist uploads profile information and a pictorial portfolio into a searchable database. The profile information includes the name of the tattoo artist, the business location of the tattoo artist, the specialties of the artist, and the price guide for the tattoo artist.

Using the customer computer, a customer can search the system database using Boolean search parameters. This filters the profile information of tattoo artists by location, specialties and price to obtain a filtered selection of tattoo artists. The customer can review the portfolio of the tattoo artists in the filtered selection. If an acceptable tattoo artist is found, the system enables direct communications between the customer computer and the artist computer of the selected tattoo artist. This enables the customer and the selected tattoo artist to come to a service agreement.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic showing the hardware requirements of the present invention system;

FIG. 2 is an image of a computer screen showing profile inputs for tattoo artists participating in the present invention system;

FIG. 3 is an image of a computer screen showing price guide inputs for tattoo artists participating in the present invention system;

FIG. 4 is an image of a computer screen showing a search screen with Boolean search fields used by customers of the present invention system.

### DETAILED DESCRIPTION OF THE DRAWINGS

Although the present invention system and method can be used to select many types of artisans, such as portrait painters, sculptors, photographers, plastic surgeons and the like, the present invention system and method is especially useful in selecting tattoo artists. Accordingly, the exemplary embodiment is adapted for use in selecting a tattoo artist. The embodiment is selected in order set forth one of the best modes contemplated for the invention. The illustrated embodiment, however, is merely exemplary and should not be considered a limitation when interpreting the scope of the appended claims.

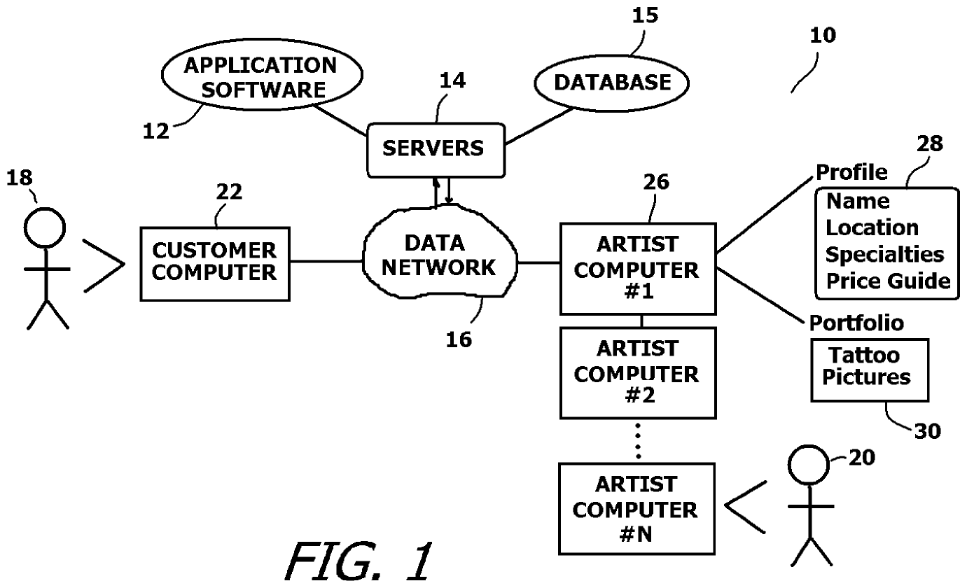

The purpose of the present invention system is to provide a person with the ability to find and commission an artist, such as a tattoo artist, to do work. Referring to FIG. 1, the hardware requirements of the present invention system 10 are shown. The system 10 utilizes application software 12 that is run, in part, by one or more computer servers 14. The computer servers 14 also maintain a database 15. The database 15 is searchable using Boolean search parameters, as is later explained. The computer servers 14 are accessible through a data network 16, such as a cellular network and/or the Worldwide Web.

The system 10 is accessed both by potential customers 18 and by participating artists 20. A customer 18 accesses the system 10 using a computing device 22 with a display 24, such as a desktop computer, a laptop customer, or a smart phone. The customer 18 can access a website that is running the application software 12 of the server 14. Otherwise, the customer 18 can download an app that works in unison with the application software 12 being run by the server 14.

The participating artists 20 also interact with the system 10 using their own computers. Each artist has an artist computer 26 into which the artist uploads an artist profile 28 and a referenceable artist's portfolio 30 into the searchable database 15.

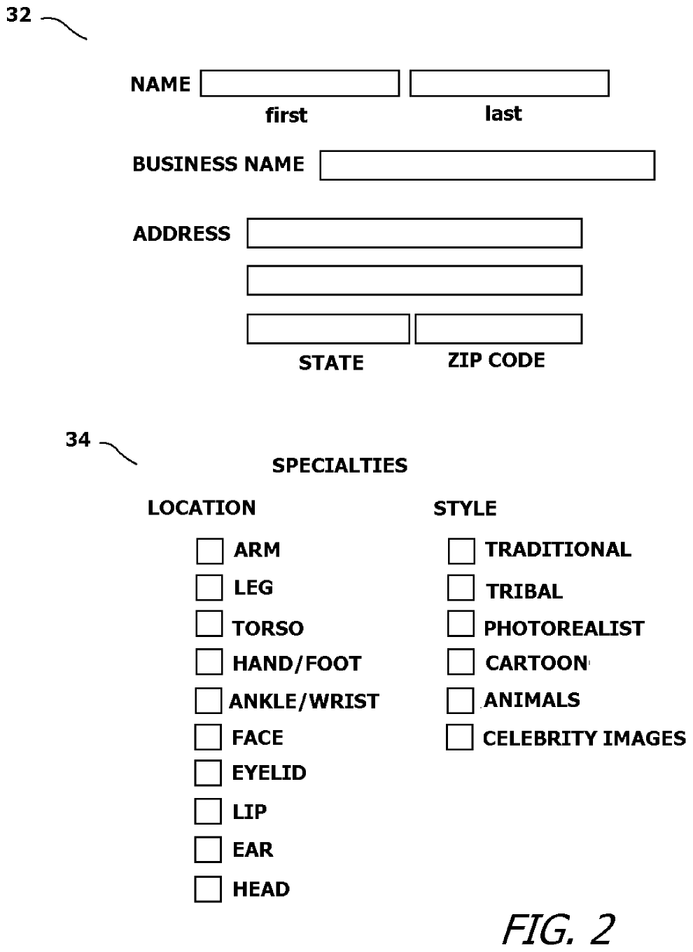

Referring to FIG. 2 in conjunction with FIG. 1, it can be seen that each artist 20 must register to use the system 10. In registering for participation in the system 10, each artist 20 creates a profile by responding to a series of screens and prompts. In a first screen of prompts 32, the artist 20 must enter this/her name and location. The name can be the name of the artists and/or the name of the artist's business, if that is how they interface with the public. The location is the address where the artist 20 conducts business, including street address, town, state and zip code.

In addition to name and location, the artist 20 must also select their practice specialties. That is, the artist 20 must select the tattoo styles that they can produce as well as identify the parts of the body where the artist 20 can place such tattoos. Specialized tattoos, such as face tattoos and ear tattoos, require specialized equipment. An artist 20 will only select the specialized tattoo types for which the artist 20 has the equipment and experience needed to produce.

The artist 20 can select the tattoo type and the tattoo specially in a number of ways. In FIG. 2, such selections are made by simply checking the appropriate boxes in a selection menu 34.

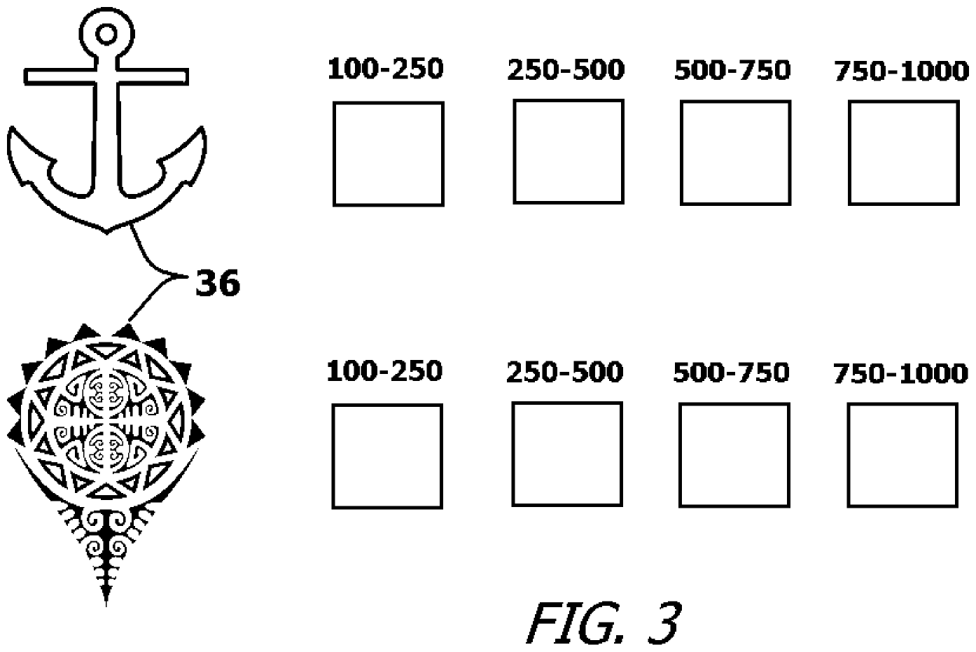

Another important part of the tattoo artist's profile is the artist's price guide. Pricing art is subjective. Different tattoo artists may have different concepts of what constitutes an “inexpensive” tattoo and what constitutes an “expensive” tattoo. Referring to FIG. 3, it will be understood that to eliminate the subjective element, the tattoo artists 20 are provided with images of exemplary tattoos 36. The exemplary tattoos 36 correspond to the specialties indicated by the tattoo artist 20. For example, if a tattoo artist 20 indicates that he/she is specialized in creating tribal tattoos on the face, then the artist 20 will be shown exemplary picture of tribal tattoos on the face. The tattoo artist 20 would then have to select the price range that the tattoo artist 20 would charge to reproduce the exemplary tattoo 36. The same exemplary tattoos 36 would be shown to all participating tattoo artists 20 that select the same specialties. In this manner, a customer 18 will be able to evenly compare the costs of different tattoo artists 20.

In addition to the artist profile 28, each artist uploads an artist's portfolio 30 to the searchable database 15. The artist uploads pictures of their artwork in the specialties they previously selected. Each artist 20 can download as many photographs as the artist likes. Once the profile pictures are downloaded, the registration of the tattoo artist 20 is complete and tattoo artist 20 is now a participating artist.

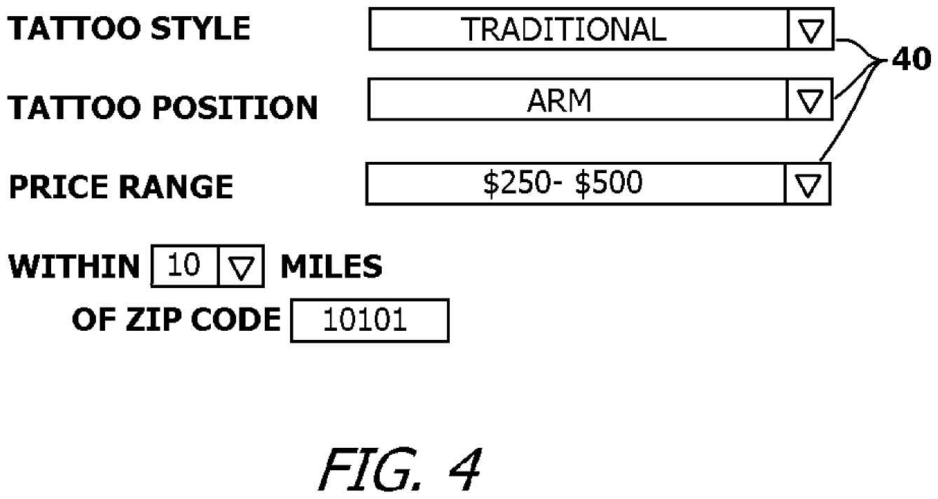

Referring to FIG. 4 in conjunction with FIG. 1, it will be understood that when a customer 18 accesses the system 10, the customer 18 must also register with the system 10 by establishing an account. In establishing an account, the customer 18 provides basic contact information such as name, address and email address. Once registered, the customer 18 is provided with a search screen 38 where they can conduct a Boolean search of the database 15. To perform the Boolean search, the customer 18 is provided with Boolean search fields 40. The Boolean search fields 40 enable the customer 18 to select the type of tattoo desired, and the place on the body where that tattoo is to be created. The application software 12 uses these criteria to create a commission request. The Boolean search also enables the customer 18 to select a geographical area, such as an area within a number of miles of the registration address. This feature is very useful in finding tattoo artists who work from their homes or otherwise have a small commercial profile. This search function enables the customer 18 to narrow the field of potential tattoo artists to artists that are in a desired geographical area. Lastly, a price range can optionally be included as part of the Boolean search, wherein the customer 18 selects a desired range for price of the tattoo.

The software application 12 conducts the Boolean search and matches the input search criteria with the various artist profiles of the participating artists 20. The customer 18 is provided with access to all the artist profiles 28 that match the search criteria via the computing device 22. The user can then review the profiles 28 and look through the portfolios 30 of the tattoo artists 20 that are of interest.

Referring to FIG. 4 in conjunction with FIG. 1, it will be understood that once a customer 18 has decided upon a tattoo artist 20, the customer 18 selects the tattoo artist 20 using the computing device 22. This completes a commission request by the system 10. The system 10 then forwards the commission request to the artist computer 26 of the selected artist. The tattoo artist 20 reviews the customer's request, wherein the tattoo artist 20 can accept, refuse, or refer the commission request. Some tattoo artists 20 are busier than others. As such, some tattoo artists may have a backlog of appointments, where no appointments are available for weeks or months. If this is the case, an estimate of appointment time is provided to the customer 18 through the system 10.

With the artist profile 28 reviewed and the artist availability of the artist 20 known, the customer 18 can contact the tattoo artist 20 using the present invention system 10. The customer 18 and artist can communicate through the system 10, wherein the parties can agree to terms concerning a particular tattoo. If parties cannot come to terms, or if the tattoo artist 20 believes that another tattoo artist 20 is more qualified for the requested task, then the tattoo artist 20 can offer a referral to another member artist 20.

If the tattoo artist 20 accepts the commission request, the system 10 can be used to schedule an appointment at the shop of the tattoo artist 20 at a mutually convenient time. The terms of payment are agreed to, wherein the tattoo can be paid for in full or in part. If the commission request is refused, the customer 18 is returned to the search results screen of the prior Boolean search.

As mentioned, it may occur that a tattoo artist 20 does not have the tools and/or ability to complete a particular commission request. If this is the case, the tattoo artist 20 can refer the commission request to another participating artist 20 who may have the skill set required to create the tattoo. Upon a referral, the profile of the referred tattoo artist is sent the customer for approval. If approved, the original tattoo artist 20 may receive a part of the paid fee as a referral fee.

Some people who obtain tattoos obtain many tattoos over time. These tattoos may be of different styles and many are in different positions on the body. As such, some customers 18 are repeat customers. Each time the customer 18 uses the system 10, the customer 18 can be given credits that can be used in the future. The number of credits can be determined by the cost of previous tattoos obtained through the present invention system 10. This provides incentive for customers 18 to use the present invention system 10 in the future, should the customer 18 desire another tattoo. The credits obtained by a customer 18 can be redeemed with any tattoo art 20 who participates in the system 10.

The customer 18 becomes a walking billboard for the tattoo artist 20. If asked by an inquirer, the customer 18 can show their tattoos and provide information on the artist and price of those tattoos. As a customer 18 creates referrals for tattoo artists 20, that customer 18 can earn additional system credits. In this manner, a customer 18 may be able to earn a free tattoo by referring enough work to participating artists.

It will be understood that the embodiment of the present invention that is illustrated and described is merely exemplary and that a person skilled in the art can make many variations to that embodiment. All such embodiments are intended to be included within the scope of the present invention as defined by the appended claims.

What is claimed is:

1. A system for commissioning a tattoo artist, comprising:
at least one server that is accessible through a data network;
a customer computer that can communicate with said at least one server through said data network;
a plurality of artist computers that can communicate with said at least one server through said data network, wherein each of said artist computers is used to upload profile information about a different artist and a portfolio for said artist, wherein said profile information includes name of said artist, business location of said artist, specialties of said artist and a price guide for said artist;
wherein said customer computer is programmed to filter said profile information of each said artist by said location, said specialties and said price guide to obtain a filtered selection of artists, and
wherein said customer computer selectively displays said portfolio of at least one of said filtered selection of artists.

2. The system according to claim 1, wherein said customer computer generates a commission request and sends said commission request to a selected one of said artist computers operated by one of said filtered selection of artists.

3. The system according to claim 1, wherein said plurality of artist computers are programmed to enable a selected one of said artist computers to accept said commission request.

4. The system according to claim 1, wherein said plurality of artist computers are programmed to enable a selected one of said artist computers to refer said commission request to a different artist.

5. The system according to claim 1, wherein said plurality of artist computers belong to tattoo artists and said portfolio of each said artist shows examples of tattoos.

6. The system according to claim 5, wherein specialties of each said artist include tattoo styles and tattoo placement.

7. A system for commissioning a tattoo artist, comprising:
at least one server that is accessible through a data network;
a customer computer that can communicate with said at least one server through said data network;
a plurality of artist computers that can communicate to said at least one server through said data network, wherein each of said artist computers is used to upload profile information about a different tattoo artist and a portfolio for said tattoo artist, wherein said profile information includes business location of said tattoo artist and specialties of said tattoo artist;
wherein said customer computer is programmed to filter said profile information each said artist by said location, said specialties and said price to obtain a filtered selection of artists from which a selected tattoo artist is chosen, and
wherein said system enables said customer computer to communicate with said selected tattoo artist via one of said plurality of artist computers and arrange a commission request for work.

8. The system according to claim 7, wherein said system displays said portfolio of said selected tattoo artist on said customer computer display.

9. The system according to claim 7, wherein said plurality of artist computers are programmed to enable said selected tattoo artist to refer said commission request to a different tattoo artist.

10. A system for commissioning a tattoo artist, comprising:
a customer computer that is networked with a plurality of artist computers through a data network;
a database accessible by said customer computer and said plurality of artist computers, wherein said database contains profile information for tattoo artists that have access to said plurality of artist computers, said profile information including business locations of said tattoo artists, specialties of said tattoo artists, price guides for said tattoo artists and pictorial portfolios for said tattoo artists;
wherein said customer computer is programmed to filter said profile information of said tattoo artists by said location, said specialties and said price guide to obtain a filtered selection of artists, and
wherein said customer computer selectively displays one of said portfolios of at least one of said filtered selection of artists, and
wherein said system enables two-way communications between said customer computer and any of said plurality of artist computers selected through said customer computer.

11. The system according to claim 10, wherein said pictorial portfolios for each said tattoo artists shows examples of tattoos.

12. The system according to claim 11, wherein said specialties of said tattoo artists include tattoo styles and tattoo placement.
